(19) United States
(12) Patent Application Publication
(10) Pub. No.: US 2026/0350567 A1
(43) Pub. Date: Nov. 5, 2026

(54) METHODS AND SYSTEMS FOR MANAGING AND PROCESSING SUPPORT PAYMENTS

(71) Applicant: Child Support Technology, LLC, Sacramento, CA (US)

(72) Inventor: Raul D. Ocazionez, Sacramento, CA (US)

(21) Appl. No.: 19/195,275

(22) Filed: Apr. 30, 2025

(51) Int. Cl. G06Q 20/10; G06Q 20/14; G06Q 50/22; G06Q 50/26

(52) U.S. Cl. CPC G06Q 20/102; G06Q 20/14; G06Q 50/22; G06Q 50/26

(57) ABSTRACT

The present disclosure relates to a method and system for managing and processing support payments. The method includes receiving a dataset related to financial transactions from a plurality of sources and extracting payment transaction details based on the dataset. The method includes allocating the transaction amount across a corresponding account of the set of payers based at least on an allocation hierarchy. The method includes generating a distribution hierarchy based at least on the allocation hierarchy and the transaction amount to be disbursed to a corresponding recipient of a set of recipients, the distribution hierarchy including the set of recipients being categorized based on a first distribution type and a second distribution type. The method includes facilitating a disbursement of the transaction amount to a corresponding recipient account of the set of recipients based at least on the distribution hierarchy.

### TECHNICAL FIELD

The present invention relates generally to financial management systems and more particularly relates to a method and system for managing and processing support payments by automating financial transactions, specifically focusing on the allocation, distribution, and disbursement of transaction amounts across multiple accounts and recipients.

### BACKGROUND

Social service support programs are crucial systems that provide financial assistance, resources, and services to individuals or communities in need. These programs are typically implemented by government agencies, non-profit organizations, and other social service entities to address a wide range of issues such as poverty, unemployment, health care, housing, education, and social welfare. The aim of these programs is to improve the quality of life for the vulnerable population by ensuring that they have access to the necessary financial and social resources to meet their basic needs. Given the diverse needs of the population and the complexity of managing multiple beneficiaries, effective administration of these programs requires robust financial management systems to ensure that funds and resources are distributed accurately, fairly, and efficiently. These systems must handle a variety of tasks, including processing large volumes of applications, verifying eligibility, tracking disbursements, and maintaining compliance with regulations.

Existing financial management systems, particularly in the context of public support programs such as child support, face significant limitations due to their lack of modularity and outdated processing capabilities. The existing financial management systems are typically built in a tightly integrated manner. For instance, changes to one component, such as financial management, often require extensive redesign, programming, and regression testing to ensure that other unrelated functions aren't disrupted. This lack of modularity leads to high costs, long timelines (often 2-4 years), and significant resource allocation for updates or changes in the existing financial management systems. Moreover, the existing financial management systems are often poorly documented, making any modifications or updates difficult and expensive, requiring massive redocumentation and costly development efforts. The existing financial management systems are also burdened by inefficient, batch-based processing, which is time-consuming and incapable of handling payments and collections in real-time. In cases where a client's requirements or conditions change, the existing financial management system requires manual intervention to perform tasks such as recognizing late payments, redistributing funds, etc. The existing financial management systems also failed to allow for initial configuration/reconfiguration of a user interface and data and field-level data names to mirror current or revised program naming conventions in real-time. The existing financial management systems are unable to provide user-level configuration and selection of graphical user interface elements and preferences. Additionally, the existing financial management systems fail to support real-time configuration of payment allocation rules or data fields, which restricts flexibility and responsiveness to changing needs.

Therefore, there is a need for a modular, flexible, and scalable financial management system that can streamline and automate the allocation, distribution, and disbursement of funds across various social service support programs to overcome the aforementioned limitations, in addition to providing other technical advantages.

### SUMMARY

Various embodiments of the present disclosure disclose a method and system for managing and processing support payments along with related fees, receivables, and non-support payments.

The present disclosure discloses a system for managing and processing support payments. In an embodiment, a computer-implemented method is disclosed. The computer-implemented method performed by processing circuitry includes receiving a dataset related to financial transactions from a plurality of sources. Further, the method includes extracting payment transaction details based at least on the dataset. The payment transaction details include a set of payers and a transaction amount to be disbursed. Further, the method includes allocating the transaction amount across a corresponding account of the set of payers based at least on an allocation hierarchy. Further, the method includes generating a distribution hierarchy based at least on the allocation hierarchy and the transaction amount to be disbursed to a corresponding recipient of a set of recipients, the distribution hierarchy including the set of recipients being categorized based on a first distribution type and a second distribution type. Further, the method includes facilitating a disbursement of the transaction amount to a corresponding recipient account of the set of recipients based at least on the distribution hierarchy.

According to another embodiment, a system is disclosed. The system includes a memory including machine-readable instructions. The system also includes processing circuitry communicably coupled to the memory. The processing circuitry is configured to execute the instructions to cause the system to receive a dataset associated with financial transactions from a plurality of sources. Further, the system is caused to extract payment transaction details based at least on the dataset. The payment transaction details include a set of payers and a transaction amount to be disbursed. Further, the system is caused to allocate the transaction amount across a corresponding account of the set of payers based at least on an allocation hierarchy. Further, the system is caused to generate a distribution hierarchy based at least on the allocation hierarchy and the transaction amount to be disbursed to a corresponding recipient of a set of recipients. The distribution hierarchy includes the set of recipients being categorized based on a first distribution type and a second distribution type. Furthermore, the system is caused to facilitate a disbursement of the transaction amount to a corresponding recipient account of the set of recipients based at least on the distribution hierarchy.

According to another embodiment, a non-transitory computer-readable storage medium is disclosed. The non-transitory computer-readable storage medium includes machine-readable instructions. Further, the machine-readable instructions when executed by processing circuitry of a system, enable the system to perform a method including steps of receiving a dataset related to financial transactions from a plurality of sources. The method includes extracting payment transaction details based at least on the dataset. The payment transaction details include a set of payers and a transaction amount to be disbursed. Further, the method includes allocating the transaction amount across a corresponding account of the set of payers based at least on an allocation hierarchy. Furthermore, the method includes generating a distribution hierarchy based at least on the allocation hierarchy and the transaction amount to be disbursed to a corresponding recipient of a set of recipients, the distribution hierarchy including the set of recipients being categorized based on a first distribution type and a second distribution type. Further, the method includes facilitating a disbursement of the transaction amount to a corresponding recipient account of the set of recipients based at least on the distribution hierarchy.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1A illustrates an example representation of an environment related to at least some example embodiments of the present disclosure;

FIG. 1B illustrates an example representation of a system architecture related to at least some example embodiments of the present disclosure;

FIG. 2 illustrates a simplified block diagram of a server system, in accordance with an embodiment of the present disclosure;

FIG. 3 illustrates an example representation of a user interface (UI) depicting tabular representation of a receipt source maintenance, in accordance with an embodiment of the present disclosure;

FIG. 4 illustrates an example representation of a user interface (UI) depicting modification of an allocation hierarchy, in accordance with an embodiment of the present disclosure;

FIG. 5 illustrates an example representation of a user interface (UI) depicting maintenance of an allocation hierarchy, in accordance with an embodiment of the present disclosure;

FIG. 6 illustrates an example representation of a user interface (UI) depicting a configuration setup for a distribution hierarchy, in accordance with an embodiment of the present disclosure;

FIG. 7 illustrates an example representation of a user interface (UI) depicting modification of the distribution hierarchy, in accordance with an embodiment of the present disclosure;

FIG. 8 illustrates a flow diagram of a computer-implemented method for managing and processing support payments, in accordance with an embodiment of the present disclosure; and

FIG. 9 illustrates a flow diagram of a computer-implemented method for balance recalculation process, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or conjunction with each other, one skilled in the art will appreciate that many of these features can be provided independently of other features.

### Overview

The present disclosure encompasses several embodiments of a method and system for managing and processing support payments.

In an embodiment, a computer-implemented method is disclosed. The computer-implemented method performed by processing circuitry includes receiving, by processing circuitry, a dataset related to financial transactions from a plurality of sources. Further, the method includes extracting, by the processing circuitry, payment transaction details based at least on the dataset. The payment transaction details include a set of payers and a transaction amount to be disbursed. Further, the method includes allocating, by the processing circuitry. The transaction amount across a corresponding account of the set of payers is based at least on an allocation hierarchy. Further, the method includes generating, by the processing circuitry, a distribution hierarchy based at least on the allocation hierarchy and the transaction amount to be disbursed to a corresponding recipient of a set of recipients. The distribution hierarchy includes the set of recipients being categorized based on a first distribution type and a second distribution type. Further, the method includes facilitating, by the processing circuitry, a disbursement of the transaction amount to a corresponding recipient account of the set of recipients based at least on the distribution hierarchy.

Further, the system includes the payment transaction details, the payment transaction details include at least a transaction identifier (ID), a transaction date and time, payment amount, payment source information, at least one payment method, and a transaction type. The system further includes the processing circuitry, configured to generate the allocation hierarchy based on a set of allocation parameters. The system further includes the set of allocation parameters including at least a priority order, a classification, an obligation category associated with the classification or subtypes of the obligation category, an allocation amount, a receipt date for received transaction amount and an effective payment date for the disbursement of the transaction amount. The distribution hierarchy is modified based on receipt type, type of a case, priority order of obligation arrear categories, a description related to the type of case, effective date, and update date of the distribution hierarchy. The system further includes the first distribution type includes an assigned distribution type and the second distribution type includes an unassigned distribution type. The system further includes the processing circuitry that is configured to update results of the allocation hierarchy based on updated payment transaction details to reflect any changes in allocations of transaction amounts.

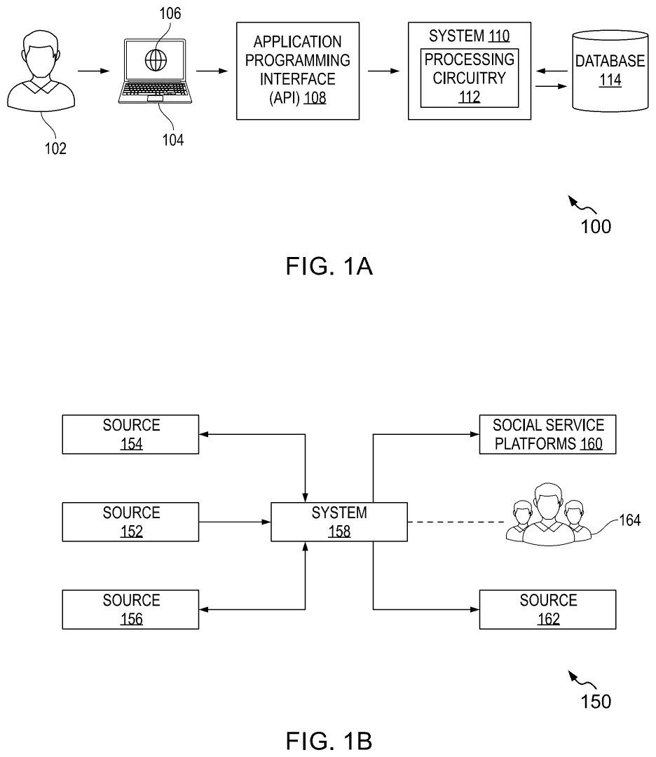

Various embodiments of the present invention are described hereinafter with reference to FIGS. 1A and 1B to FIG. 9.

FIG. 1A illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The present disclosure is described with reference to managing and processing support payments. Alternatively, the environment 100 may be implemented to perform case management, financial accounting, reporting, and data management applicable to public social service programs. The environment 100 may be implemented to manage and process receivables and non-support payments.

The environment 100 includes a user 102 associated with a user device 104. The user device 104 may include at least a laptop computer, a phablet computer, a handheld personal computer, a virtual reality (VR) device, a netbook, a web book, a tablet computing device, a smartphone, or other mobile computing devices.

Further, the environment 100 includes a system 110 associated with an application programming interface (API) 108, and a database 114 connected to, and in communication with (and/or with access to) a wireless communication network (e.g., a network such as Internet). The user device 104 is connected with the system 110 (also referred to as ‘the server system 110’) through the wireless communication network (hereinafter interchangeably referred to as network or internet) such as the Internet. In a non-limiting example, the user 102 can be a support program worker (e.g., case workers, financial worker, and leadership staff), having access to the system 110.

The environment 100 further depicts the API 108, which transmits data received from the user device 104, and serves as an intermediary between the user device 104 and the system 110. The data includes at least login credentials, additional recipients' details, user input on system generated receipts, user selected configuration and parameters, and preferences of graphical user interface (GUI) elements. The API 108 further transmits the data to the system 110 via the network. For example, the user 102 initiates a request or an action on the user device 104, such as submitting a query, entering data, or requesting specific information. The API 108 is configured to receive the user request, process it as necessary (e.g., validating the input or converting the data into a format suitable for the system 110), and forward the request to the system 110. The system 110 further includes a processing circuitry 112. The processing circuitry 112 may receive the user request via the API 108 and execute the necessary computations, processing the data, and carrying out any required logic to fulfill the user request. In some instances, the system 110 may require additional information to complete the user request. To obtain this information, the system 110 interacts with the database 114. The database 114 stores relevant data, such as user information, transaction records, or any other type of data that may be needed to fulfill the user request. The system 110 queries the database 114 to retrieve, update, or manipulate the stored data as needed for the user request. After the system 110 completes the necessary processing and data retrieval, the system 110 may generate a response and transmit the response to the user device 104.

In an embodiment, the system 110 is deployed as a standalone server or can be implemented in a cloud-based architecture as software as a service (SaaS). The system 110 provides or hosts a support payment management platform 106 (hereinafter also termed as a support payment management application 106) for facilitating aggregation of the user data or input data, collecting amounts (e.g., transaction amount or funds received from an entity), validating transactions, and managing data related to the transactions. The system 110 includes processing circuitry 112. The processing circuitry 112 may be configured to execute software instructions and manage the hardware resources required to support various functions such as generating receipts, handling the allocation process, distribution process, and disbursement process related to supporting payments to recipients.

For instance, the support payment management platform 106 is also accessible to the user device 104 via an interface (e.g., a web-based interface). Further, the user 102 may be any individual, an organization, a government agency or department, a representative of a corporate entity, a non-profit organization, a company, a bank, an insurance company, an educational institution, and the like. The user 102 may be any person or an entity such as an organization or individual. Such users may range from entities such as social support program organizations to those responsible for managing, allocating, and distributing transaction amounts across multiple accounts and recipients.

Furthermore, the database 114 may be adapted to store basic information, such as, but not limited to, critical information related to transactions of support payments, such as transaction identifiers (IDs), transaction dates and times, payment amounts, payment source information, payment methods, and transaction types. Additionally, the database 114 may store data regarding an allocation hierarchy and a distribution hierarchy, including a priority order, classification, and obligation categories associated with the payment transactions.

It should be noted that the number of the users, the user device 104, the system 110, and the database 114 described herein are only used for exemplary purposes and do not limit the scope of the invention. The main objective of the invention is to provide the support payment management platform 106 to automate and streamline the management and processing of support payments. The system and method aim to efficiently allocate, distribute, and disburse transaction amounts by leveraging an organized hierarchy-based approach. This ensures that transaction details are correctly processed and routed to appropriate accounts, based on predefined parameters and various conditions (e.g., obligations). In a non-limiting example, the user 102, has to be authenticated to have access to the support payment management platform 106.

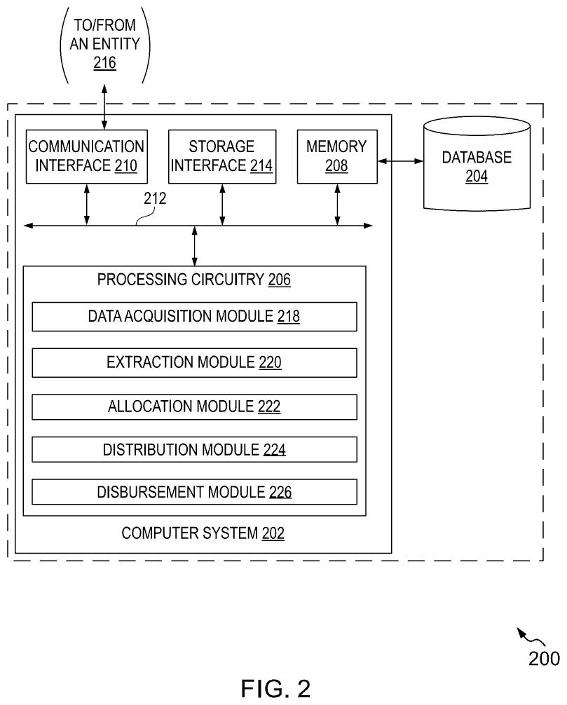

Further, a detailed explanation of the configuration of the system 110 with examples is explained later in the description with references to FIG. 2 and FIGS. 3-7.

FIG. 1B illustrates an example representation of a system architecture 150 related to at least some example embodiments of the present disclosure. For example, the system architecture 150 is similar to the environment 100 as described in FIG. 1A. The system architecture 150 is configured to facilitate the automated processing and management of support payments. In an embodiment, the system architecture 150 includes a plurality of sources such as a source 152, a source 154, a source 156, and a source 162 communicably coupled with the system 158 via a wireless communication network or a network (e.g., Internet). The system 158 is an example of the system 110 of FIG. 1A. The sources 152, 154, and 156 may include an entity or an organization such as public social service departments or a revenue/treasury department. The sources 152, 154, and 156 provide financial transaction data along with receipts to process the various support payments. The system 158 receives such financial transaction data and aggregates it into a dataset. The system 158 further utilizes the dataset for performing one or more tasks such as, but not limited to, extracting payment transaction details, extracting payer information, allocating transaction amounts according to the allocation hierarchy, and generating the distribution hierarchy for disbursing the transaction amounts across multiple recipient accounts.

In a non-limiting example, consider the source 152 as a first social service department that provides the financial transaction data such as assistance information, case and order details (e.g., court order related to child care or spousal support), and enforcement information to the system 158. The system 158 transmits financial event details and work list items to the source 154 after processing the support payments. If the system 158 receives collection details (e.g., transaction amount received from one of the social service department or a federal department) along with payment identification data and check status via an electronic file from the source 154, then the system 158 transfers payment status (e.g., checks) to the source 154 after processing the support payments. The system 158 further transmits the collection details to other social service platforms 160, which are connected with the system 158 via the network. The social service platforms 160 may send data feeds to the system 158 regarding eligibility criteria, changes in the recipient's obligations, arrears, or updates in the recipient's legal status (such as a change in the court order). The social service platforms 160 could be connected via application programming interfaces (APIs) (such as the API 108).

In an embodiment, the support payment management platform 106 may receive information such as modification in personal details, recipient's data, and payments against additional received amounts as disbursement (e.g., receivable payments from a set of recipients 164).

FIG. 2 illustrates a simplified block diagram of a system 200, in accordance with an embodiment of the present disclosure. For example, the system 200 is an example of the system 158 and/or the system 110. In some embodiments, the system 200 is embodied as a standalone physical server and/or has a cloud-based and/or SaaS-based (software as a service) architecture. The system 200 is configured to facilitate the automated processing and management of support payments. The system 200 is capable of receiving transaction details, extracting payer information, allocating transaction amounts according to the allocation hierarchy, and generating the distribution hierarchy for disbursing the payment amounts across multiple recipient accounts. The process of managing the allocation and distribution hierarchies, as well as facilitating disbursements based on the transaction details, is explained later in the present disclosure.

The system 200 includes a computer system 202 and a database 204. The computer system 202 includes at least one processor, such as a processing circuitry 206 for executing instructions, a memory 208, a communication interface 210, a bus 212, and a storage interface 214. The bus 212 enables entities of the computer system 202 to communicate with each other. The database 204 is an example of the database 114 of FIG. 1A.

In some embodiments, the database 204 is integrated into the computer system 202. For example, the computer system 202 may include one or more hard disk drives as the database 204. The storage interface 214 is any component capable of providing the processing circuitry 206 with access to the database 204. The storage interface 214 may include, for example, an advanced technology attachment (ATA) adapter, a serial ATA (SATA) adapter, a small computer system interface (SCSI) adapter, a RAID controller, a SAN adapter, a network adapter, and/or any component providing the processing circuitry 206 with access to the database 204.

It is to be noted that although the computer system 202 is depicted to include only one processor, the computer system 202 may include a greater number of processors therein. The processing circuitry 206 includes a suitable logic, circuitry, and/or interfaces to execute computer-readable instructions for performing one or more operations for managing and processing support payments. Examples of the processing circuitry 206 include, but are not limited to, an application-specific integrated circuit (ASIC) processor, a reduced instruction set computing (RISC) processor, a complex instruction set computing (CISC) processor, a field-programmable gate array (FPGA), and the like.

In an embodiment, the memory 208 is capable of storing the computer-readable instructions. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In another embodiment, the memory 208 may be realized in the form of a database server or a cloud storage working in conjunction with the system 200, without departing from the scope of the present disclosure.

The processing circuitry 206 is operatively coupled to the communication interface 210 such that the computer system 202 is capable of communicating with an entity 216 such as the user device 104 or with any entity of FIGS. 1A and 1B. In one embodiment, the processing circuitry 206 is configured to facilitate installing an instance of the support payment management platform 106 in the system 102. This enables the implementation of a plurality of functionalities by multiple entities described in the disclosure.

It is to be noted that the system 200 as illustrated and hereinafter described is merely illustrative of an apparatus that could benefit from embodiments of the present disclosure and, therefore, should not be taken to limit the scope of the present disclosure. It is noted that the system 200 may include fewer or more components than those depicted in FIG. 2.

The processing circuitry 206 includes a data acquisition module 218, an extraction module 220, an allocation module 222, a distribution module 224, and a disbursement module 226. It should be noted that components, described herein, can be configured in a variety of ways, including electronic circuitries, digital arithmetic and logic blocks, and memory systems in combination with software, firmware, and embedded technologies. In an embodiment, the data acquisition module 218, the extraction module 220, the allocation module 222, the distribution module 224, and the disbursement module 226 are operatively coupled with each other for exchanging information with each other.

Further, the data acquisition module 218 is configured to acquire the dataset from a plurality of sources (e.g., source 152, source 154, source 156). The sources 152, 154, and 156 may be entities or public departments (e.g., federal department) that provide financial transaction data such as the dataset, related to payers and the recipients 164 involved in support payments.

Further, the extraction module 220 extracts payment transaction details from the dataset and transfers the payment transaction details to the allocation module 222 and the distribution module 224 for further processing. The payment transaction details includes but are not limited to, at least a transaction identifier (ID), a transaction date and time, payment amount, payment source information, at least one payment method (e.g., recipient's chosen disbursement method such as a direct deposit, a debit card, an automated clearing house (ACH), a physical check), and a transaction type. The extraction module 220 is also configured to extract details such as a set of payers and a transaction amount to be disbursed (e.g., amount received from a federal department or an entity) from the payment transaction details.

The term “payer” used herein refers to an individual or an entity responsible for making a payment as part of a financial transaction corresponding to a support service. The payer initiates a payment process and is obligated to provide the transaction amount to the set of recipients 164, based on the distribution hierarchy defined within the system 200. The term “recipient” used herein refers to an individual or an entity designated to receive a payment in a financial transaction corresponding to a support service. A recipient could be a person or a group of individuals (e.g., family members), a department, or an organization to whom the payer sends funds as support payment. This way, the recipient's account receives the disbursed transaction amount. The term “transaction amount” used herein refers to the total amount of money involved in a payment transaction. This is the amount that is transferred from the payer and may be subject to allocation based on the allocation hierarchy defined by the system 200.

In an embodiment, the allocation module 222 is configured to allocate the transaction amount across a corresponding account of the set of payers based at least on the allocation hierarchy. The allocation hierarchy defines a priority order in which different portions of the transaction amount are distributed across accounts of the set of payers based on predefined criteria such as payment priority, obligation categories, or other parameters. In an embodiment, the allocation module 222 is configured to allocate of the transaction amount across accounts that are associated with payer's cases.

In an embodiment, the allocation hierarchy is generated by the processing circuitry 206 based on a set of allocation parameters. The term “allocation parameters” used herein refers to parameters used to determine how the total transaction amount should be allocated among multiple cases (e.g., payer's cases). The set of allocation parameters includes at least a priority order, a classification, an obligation category associated with the classification or subtypes of the obligation category, an allocation amount, a receipt date for received transaction amount and an effective payment date for the disbursement of the transaction amount.

The term “priority order” used herein refers to a ranking or a sequence applied to determine the order in which various obligations associated with the transaction amount should be paid or processed. It is to be noted that, when the transaction amount or received payment is insufficient to satisfy all of the payer's debts, the allocation hierarchy ensures that the highest priority debts are satisfied first, and that lower priority debts are satisfied by future payments. Priority order ensures that higher-priority payments are satisfied first, based on user preferences. The term “obligation category” used herein refers to a classification system that categorizes various types of financial obligations associated with a transaction. For example, an obligation category might include categories such as “child support”, “spousal support”, or “child care”. For instance, each classification may contain multiple obligation types, configurable by the user 102 or the entity 216.

For example, the child support classified obligation category includes but is not limited to child care, child support, out-of-state support, and county foster care. Obligations have two subtypes such as current and judgment. Current subtype obligations are used for accruing the obligor's periodic support amount. Judgment obligations may be used when a judge orders past due amounts to be paid according to periodic frequency, or, for example, to reimburse the court for various court costs (e.g., hearings and appeals, ad litem, extraordinary paternity testing, legal fees, etc.).

The term “effective payment date” used herein refers to the date, the allocation and distribution processes use when the payment is applied to that effective date. Generally, the effective payment date is the same as the day the dataset is received by the system 200. However, the effective payment date may be in the past, in which case the debts as of that date will be used, and the payment's effect on the debts will be recorded as of that date. The term “receipt date” used herein refers to the date on which the payer's transaction amount is received by the system 200. The receipt date marks the point when the funds become available for processing, allocation, and disbursement.

In an embodiment, the processing circuitry 206 is configured to update results of the allocation hierarchy based on updated payment transaction details to reflect any changes in allocations of transaction amounts.

Further, the distribution module 224 is configured to generate the distribution hierarchy based at least on the allocation hierarchy and the transaction amount to be disbursed to a corresponding recipient of the set of recipients 164. The distribution hierarchy includes the set of recipients 164 being categorized based on a first distribution type (e.g., assigned distributions) and a second distribution type (e.g., unassigned distributions). The distribution hierarchy that defines how the transaction amounts are to be allocated and disbursed to the set of recipients 164. In a non-limiting example, the distribution hierarchy defines distribution of the transaction amount are across debts and such debts may have different recipients based on a case and payment conditions, and such recipients may have multiple debts on the same case for a payer. The distribution hierarchy serves to categorize the set of recipients 164 into distinct groups or categories to ensure that each recipient of the set of recipients 164 receives an appropriate share of the disbursed amount. For example, assigned distributions refer to the portion of a debt owed to a state, as per the distribution hierarchy, at a specific point in time. While the debt is classified as assigned, it does not always mean that the entire debt is owed to the state. Unassigned distributions refer to the portion of the debt that remains owed to a family, as opposed to the state (e.g., the debt is not assigned to the state and remains with the family as per the distribution hierarchy at that time).

The set of recipients 164 in the distribution hierarchy is divided into categories based on two distribution types such as the first distribution type and the second distribution type. The first distribution type consists of recipients among the set of recipients 164 who have been explicitly designated to receive specific amounts of the transaction. These recipients may have high-priority claims or obligations, often based on legal or contractual arrangements. Their distribution share is determined according to the allocation hierarchy. The second distribution type consists of recipients among the set of recipients 164 who have not been assigned specific amounts from the available transaction amount. These recipients may receive a share of the remaining balance after the recipients in the assigned distribution type have been allocated their amounts.

In an embodiment, the distribution hierarchy is modified based on receipt type, type of a case, priority order of obligation arrear categories, a description related to the type of case, effective date, and update date of the distribution hierarchy.

Further, the disbursement module 226 is configured to facilitate a disbursement of the transaction amount to a corresponding recipient account of the set of recipients 164 based at least on the distribution hierarchy. The disbursement module 226 is responsible for facilitating the actual transfer of transaction amounts to the appropriate recipients 164 based on the generated distribution hierarchy.

In particular, the disbursement module 226 identifies the recipient accounts based on the distribution hierarchy, which categorizes the recipients 164 into high-priority and low-priority groups (e.g., assigned distribution types and unassigned distribution types). The distribution hierarchy determines the recipients 164 are to be paid and the amounts they receive. Based on the distribution hierarchy, the disbursement module 226 facilitates the transfer of funds to each recipient's account. The disbursement module 226 is configured to handle various payment methods for transferring the transaction amounts, such as electronic funds transfers (EFT), wire transfers, checks, or direct deposits. The disbursement module 226 ensures that the funds are sent to the recipients 164 using the appropriate payment method, as specified by the recipients' preferences. The disbursement module 226 may dynamically adjust the disbursement process based on any real-time changes to the distribution hierarchy. In a non-limiting example, if new data (e.g., updated conditions) is received from the sources 152, 154, and 156 or if there is an update to the status of a recipient's obligation, the distribution module 224 ensures that the disbursement reflects these changes. For example, “updated conditions” comes from one of the plurality of sources such as State Disbursement Unit (SDU) or Child Support Enforcement System (CSES), and a user entering in new information. The CSES may receive information from a partner agency or data source. Updated conditions include order modifications that change the amount, time span, number of dependents, or obligation type. All of these changes would trigger a balance recalculation process, which would then create new transactions against the respective case balance and redetermine how previous payments were distributed and disbursed and make a determination on whether new disbursements are needed based on the new information.

For example, a government department responsible for distributing financial assistance. The disbursement module 226 further transfers the appropriate amounts to the recipients' accounts (such as a bank account), ensuring disbursement of the transaction amounts to the corresponding recipients of the set of recipients 164 using the specified payment methods.

In an embodiment, the system 200 allows the user 102 or the entity 216 to configure “global configurations” via a user interface (UI) such as a graphical user interface (GUI). The global configurations provides an exhaustive list of all screen names, labels, descriptions, IDs, list categories, etc. to be configured individually by the entity 216 or the user 102 to align terms of the system 200 to match that of terms of a social service program (e.g., client's program terms).

In an embodiment, the system 200 allows the user 102 or entity 216 to configure screen labels via the UI. The screen labels provide the ability to customize all on-screen terms and hover text within the system 200. This capability allows for ease of updating the screen labels. The screen labels display a list of options including but are not limited to, an ID, category, item, long value, short value, hover text, comment, updated by (e.g., a user or a system), updated date, custom, and modification option. Additionally, the system 200 allows the user 102 or entity 216 to configure parameters via the UI. The parameters may include but are not limited to, an ID, a category, a subcategory (e.g., recipients and security), item, value, a description, comment, an effective date, and a modification option.

In another embodiment, the system 200 allows the user 102 or entity 216 to configure settings via an option “my settings” provided by the UI. This option provides the capability to the user 102 to customize their own experience by making specific choices that control how the system 200 will behave based on user-defined preferences.

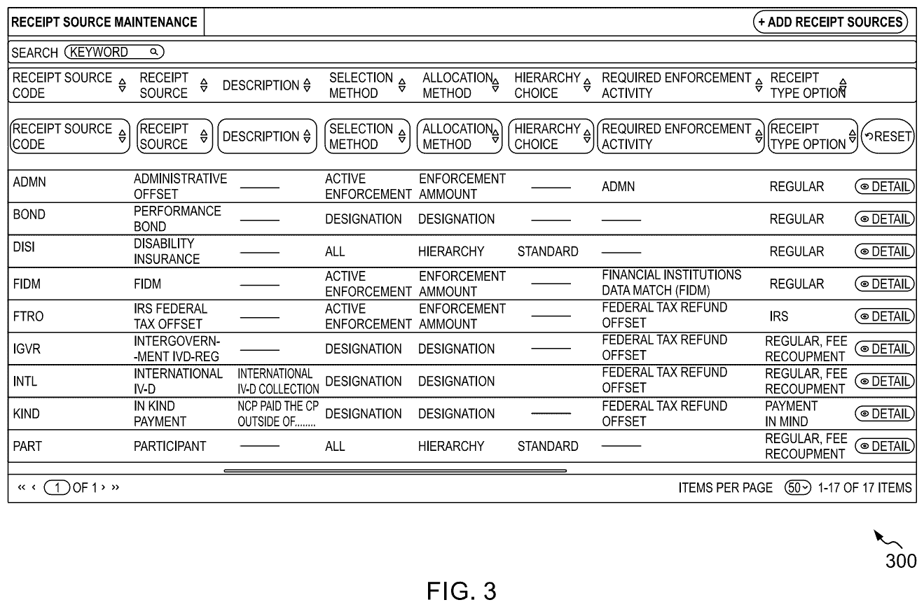

FIG. 3 illustrates an example representation of a user interface (UI) depicting tabular representation of a receipt source maintenance 300, in accordance with an embodiment of the present disclosure. The receipt source maintenance 300 or a receipt source maintenance module 300, is a feature in the support payment management platform 106 of the system 110 and/or system 158 (as shown in FIG. 1A and FIG. 1B). For example, the system 158 is an example of the system 200 and/or the system 110. The receipt source maintenance module 300 allows configuration of different receipt sources that are integrated into the system 158. Receipts are primarily obtained from an electronic file received by the system 158 from a source such as a federal department (e.g., primarily from the State Disbursement Unit (SDU)). The electronic file includes all relevant payment identification data (e.g., case numbers, amounts, payor information, and instrument IDs). The electronic file allows the system 158 to automatically identify and process the support payment without the need for manual input, streamlining the payment processing workflow. Once the payment identification data has been received from the source such as SDU (or other sources), it is then processed through the system's posting mechanism. The posting refers to an action of recording a receipt against received transaction amount into the database(s).

As shown in FIG. 3, an entity such as a client or a system admin (not shown in FIGS.) is able to configure sources of receipts into the system 158 based on configuration/selection of options provided by the receipt source maintenance module 300. These options may include but are not limited to, receipt source code, a receipt source, a description related to a corresponding receipt, a selection method, an allocation method, hierarchy choice, a required enforcement activity, and receipt type order. The client or system admin is able to add a new receipt source by selecting an option such as “add receipt source” provided by the receipt source maintenance module 300.

For each receipt source, the system 158 allows for custom processing by choosing the desired selection method, allocation method, and hierarchy method. This functionality is part of the receipt source maintenance module 300, which automates and facilitates the processing and management of various types of receipts. The receipt source maintenance module 300 allows the system administrator or client to define and configure the sources of receipts. The term “receipt source” used herein refers to different payment origins such as bank accounts, government departments (e.g., administrative offset IRS federal tax offset), etc. The sources of receipts provide payments or transaction amounts related to various support programs.

For each receipt source, the system 158 allows for specific configuration based on three primary methods explained as follows: For example, the selection method determines how payer's cases are identified or selected for processing or a designation, a case number, a payment type such as an active enforcement or other criteria). For example, the allocation method defines how the payments will be distributed or allocated to various obligations or debts (e.g., by proportional allocation, fixed allocation amounts, enforcement amounts, hierarchy, or designation). For example, the hierarchy method specifies how the payments are to be prioritized and organized based on the choice of a hierarchy (e.g., which obligations are prioritized for payment first, such as arrears vs. current obligations). It is to be noted that, by configuring the aforementioned methods in the receipt source maintenance module 300, the system 158 handles complex payment scenarios and ensures that the correct amounts are allocated and disbursed to the appropriate recipients.

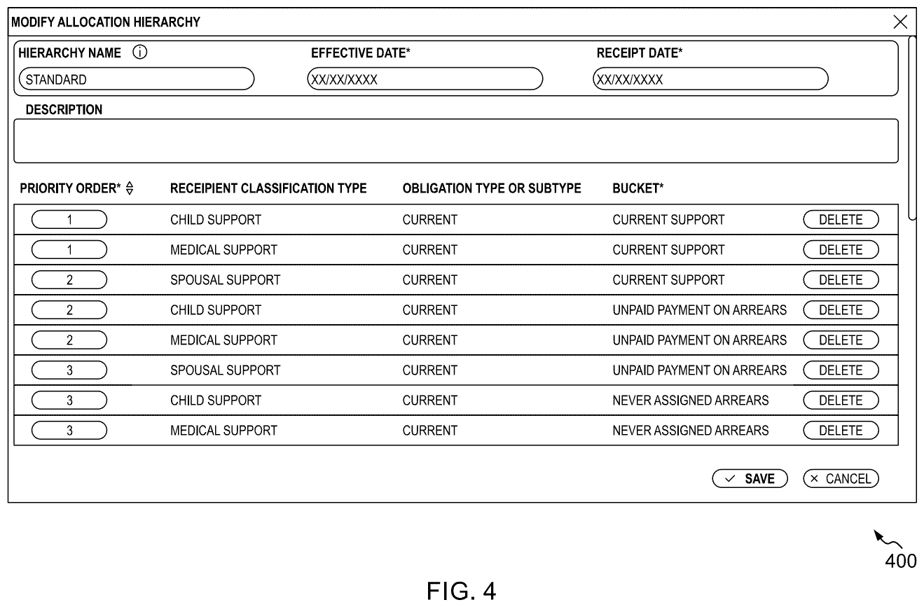

FIG. 4 illustrates an example representation of a user interface (UI) 400 depicting modification of an allocation hierarchy, in accordance with an embodiment of the present disclosure. The allocation hierarchy is a crucial component in the automated management of disbursements of support payments, particularly for processing support payments. The UI 400 enables the user 102 (or also referred to as users) to efficiently interact with the system 158, facilitating a setup, management, and modification of how transaction amounts are allocated across various cases.

In one embodiment, the UI 400 provides an intuitive, visual platform for managing the allocation hierarchy based on a set of customizable parameters. The UI 400 may be displayed on the user device's 104 screen as the graphical user interface (GUI), containing various controls such as dropdown menus, sliders, tables, and text fields that allow authorized users to modify key aspects of the allocation hierarchy.

The UI 400 allows users to set and modify a set of allocation parameters to configure an allocation order or the allocation hierarchy. The set of allocation parameters dictates how the received transaction amount is divided and assigned across different classifications. The set of allocation parameters includes, but are not limited to, at least a priority order, a classification (e.g., a child support, a medical support, and a spousal support), an obligation category (e.g., obligations for a child support classification are mentioned as follows foster care, a child care, a child support, out of state support), associated with the classification or subtypes (e.g., current obligations and/or judgment obligations) of the obligation category, bucket, an allocation amount, a receipt date for received transaction amount and an effective payment date for the disbursement of the transaction amount. For instance, each classification may contain multiple obligation types, configurable by the user 102. The obligation category may have two subtypes, current and judgment. Current subtype obligations are used for accruing the obligor's/recipient's periodic support amount. Judgment subtype obligations may be used when a judicial order, past due amounts to be paid according to periodic frequency, or, for example, to reimburse the court for various court costs (e.g., hearings and appeals, ad litem, extraordinary paternity testing, and legal fees).

Each classification may contain multiple obligation types, configurable by the user 102. Obligations may have two subtypes, current and judgment. Current subtype obligations are used for accruing the obligor's periodic support amount. Judgment subtype obligations may be used when a judicial order, past due amounts to be paid according to periodic frequency, or, for example, to reimburse the court for various court costs (e.g., hearings and appeals, ad litem, extraordinary paternity testing, and legal fees).

In a non-limiting example, the user 102 may assign a priority to recipient classification types in a descending order, ensuring that higher-priority debts or obligations (e.g., arrearages and overdue payments) are satisfied first. An example of the priority order is rank 1 for child support classification type and rank 2 for medical support classification type.

Further, the system 158 automatically calculates transaction amounts to be disbursed across corresponding accounts of a set of payers based on the generated allocation hierarchy.

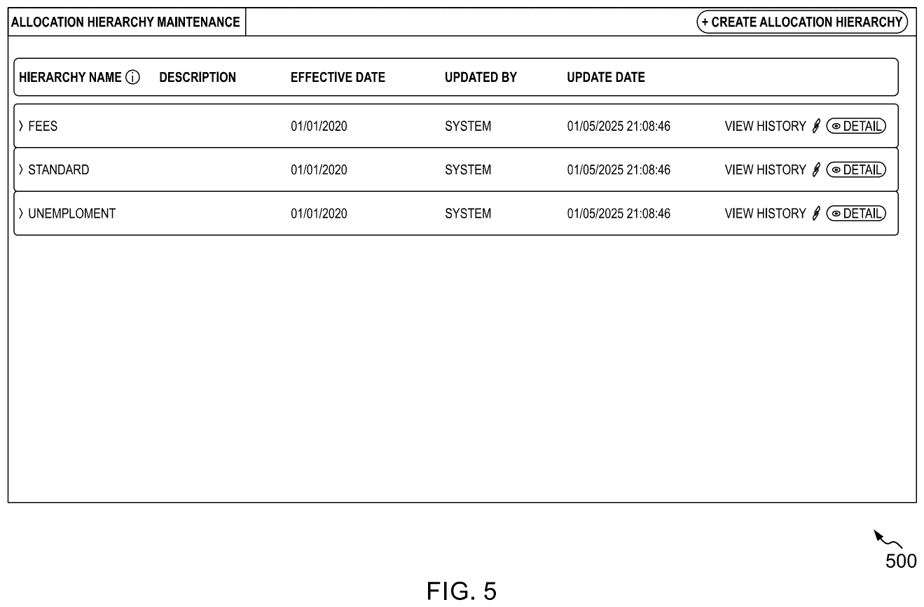

FIG. 5 illustrates an example representation of a user interface (UI) 500 depicting maintenance of an allocation hierarchy, in accordance with an embodiment of the present disclosure. The UI 500 allows authorized users 102 to view, manage, and configure the allocation hierarchy for financial transactions, ensuring that the distribution of transaction amounts is carried out according to the generated allocation hierarchy. This section of the UI 500 displays a list of available/existing allocation hierarchies, a description related to corresponding hierarchy (e.g., fees, standard, and unemployment), effective date of the corresponding hierarchy, update date of the corresponding hierarchy, updated by (e.g., the system 200 or the user 102), and historical records. The historical records option allows the users 102 to access a comprehensive history of all previous modifications made to the respective allocation hierarchy. This feature enables the users 102 to track and review past changes, compare different versions of the hierarchy, and understand the evolution of the allocation process over time.

The UI 500 provides an option (such as “create allocation hierarchy”) that allows the users 102 to create a new allocation hierarchy or remove existing ones. This flexibility ensures that the system 200 can accommodate changes in case types, legal requirements, or organizational needs. This way the users 102 are able to view, modify and maintain different allocation hierarchies.

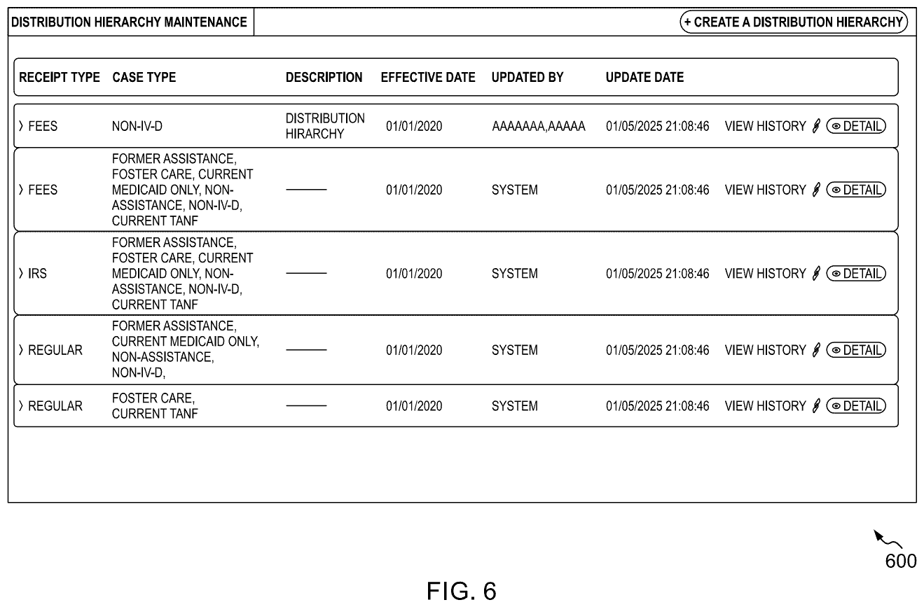

FIG. 6 illustrates an example representation of a user interface (UI) 600 depicting a configuration setup for a distribution hierarchy, in accordance with an embodiment of the present disclosure. The UI 600 enables users to view, manage, and configure each of available/existing distribution hierarchies that are involved in the disbursement of support payments (e.g., transaction amounts received from the set of payers). For example, users can view and modify each distribution hierarchy based on several customizable parameters.

This section of the user interface 600 displays receipt type, case type, a description (e.g., distribution hierarchy), effective date of corresponding hierarchy, update date of the corresponding hierarchy, updated by (e.g., the system 200 or the user 102), and historical records in a graphical or tabular format. The historical records option, allows the users to access a comprehensive history of all previous modifications made to the distribution hierarchy. This feature enables the users to track and review past changes, compare different versions of the hierarchy, and understand the evolution of the allocation process over time. The receipt type column allows the users to specify how the transaction amount is received by the payer. The receipt type may include fee, an internal revenue service (IRS), and regular. The case type column specifies a classification or category of the case associated with a transaction. An update by column automatically records a name of the user 102 or an identifier (ID) of the system 200 who last modified the distribution hierarchy configuration. This feature helps ensure transparency and accountability, allowing organizations to track who made each change to the hierarchy.

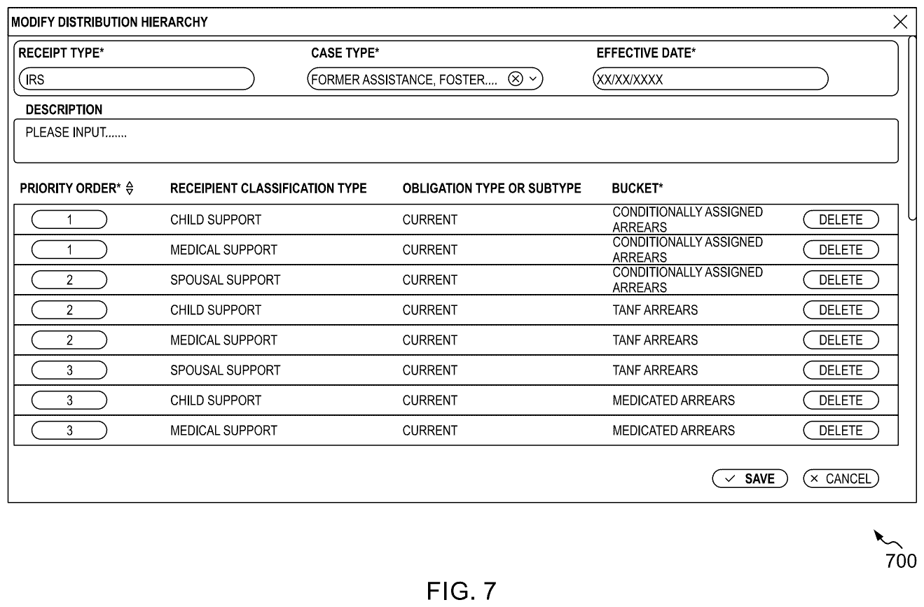

FIG. 7 illustrates an example representation of a user interface (UI) 700 depicting modification of the distribution hierarchy, in accordance with an embodiment of the present disclosure. In one embodiment, the UI 700 provides a visual platform for managing the distribution hierarchy based on a set of customizable parameters. The UI 700 may be displayed on a screen of the user device 104 as a graphical interface, consisting of various controls such as dropdown menus, sliders, tables, and text fields that allow authorized users to modify key aspects of the distribution hierarchy.

For example, the UI 700 allows users to set and modify a plurality of options to configure or modify the distribution hierarchy. The options includes but are not limited to, at least a priority order, a case type, receipt type, a recipient classification type (e.g., child support, medical support, and spousal support), an obligation category (e.g., obligations for a child support classification are foster care, child care, child support, and out of state support) associated with the classification or subtypes (e.g., current obligations and judgement obligations) of the obligation category, an allocation amount, a receipt date for received transaction amount, an effective payment date for the disbursement of the transaction amount, and bucket or arrears categories.

Buckets or arrears categories are partial balances within an overall obligation. The buckets and their functionality can be configured to meet the needs of an organization or an agency. For example, the buckets are selected from a group including but not limited to, never assigned arrears, TANF arrears, and Medicaid arrears.

For example, the user 102 may assign a priority to recipient classification types in a descending order, ensuring that higher-priority debts or obligations (e.g., arrearages, overdue payments) are satisfied first. An example of the priority order is rank 1 for child support classification type and rank 2 for medical support classification type. Further, the system 200 automatically calculates transaction amounts to be disbursed across corresponding accounts of the set of recipients 164 based on the generated distribution hierarchy. In an embodiment, the distribution hierarchy includes the set of recipients 164 being categorized based on a first distribution type and a second distribution type. The first distribution type includes an assigned distribution type and the second distribution type includes an unassigned distribution type.

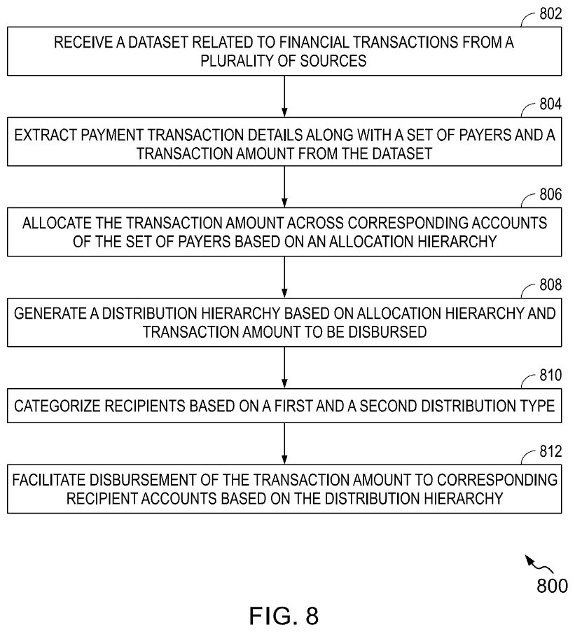

FIG. 8 illustrates a flow diagram of a computer-implemented method 800 for managing and processing support payments, in accordance with an embodiment of the present disclosure. The method 800 depicted in the flow diagram may be executed by, for example, at least one system such as the system 200. Operations of the flow diagram of the method 800, and combinations of operations in the flow diagram of the method 800, may be implemented by, for example, hardware, firmware, a processor, circuitry, and/or a different device associated with the execution of software that includes one or more computer program instructions. The method 800 starts at operation 802.

At 802, the method 800 includes receiving, by the processing circuitry 206 (e.g., the system 200), a dataset related to financial transactions from the plurality of sources 152, 154, 156, and 162.

At 804, the method 800 includes extracting, by the processing circuitry 206, payment transaction details based at least on the dataset. The payment transaction details include a set of payers and a transaction amount to be disbursed.

At 806, the method 800 includes allocating, by the processing circuitry 206, the transaction amount across a corresponding account of the set of payers based at least on an allocation hierarchy.

At 808, the method 800 includes generating, by the processing circuitry 206, a distribution hierarchy based at least on the allocation hierarchy and the transaction amount to be disbursed to a corresponding recipient of the set of recipients 164. The distribution hierarchy includes the set of recipients 164 being categorized based on a first distribution type and a second distribution type.

At 810, the method 800 includes facilitating, by the processing circuitry 206, a disbursement of the transaction amount to a corresponding recipient account of the set of recipients 164 based at least on the distribution hierarchy.

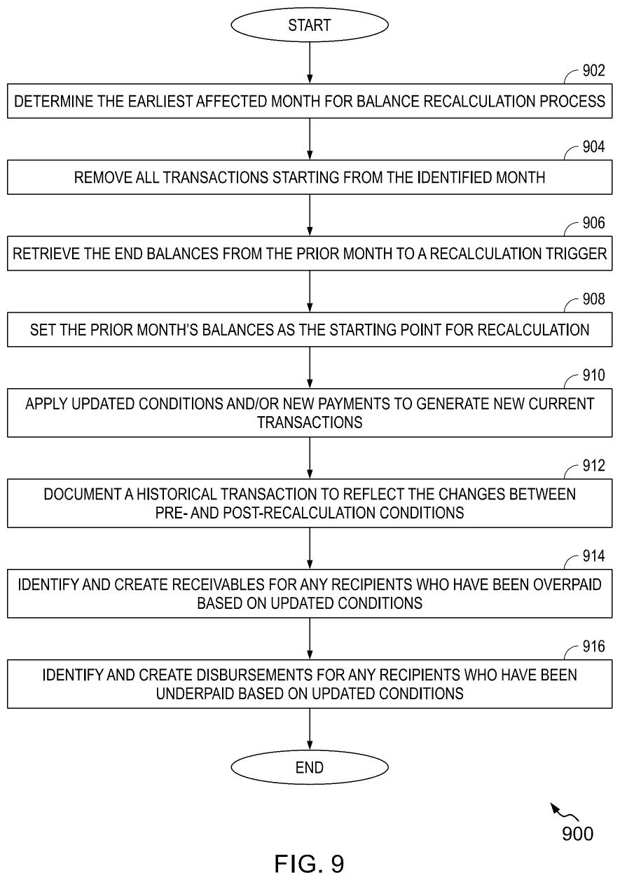

FIG. 9 is a flowchart illustrating a computer-implemented method 900 for balance recalculation process, in accordance with an embodiment of the present disclosure.

At 902, the method 900 includes determining, by processing circuitry 206, an earliest affected month for balance recalculation process.

At 904, the method 900 includes removing, by the processing circuitry 206, all transactions starting from the identified month.

At 906, the method 900 includes retrieving, by the processing circuitry 206, the end balances from the prior month to a recalculation trigger.

At 908, the method 900 includes setting, by the processing circuitry 206, the prior month's balances as the starting point for recalculation.

At 910, the method 900 includes applying, by the processing circuitry 206, updated conditions and/or new payments to generate new current transactions.

At 912, the method 900 includes documenting, by the processing circuitry 206, the updated conditions and/or new payments to generate new current transactions.

At 914, the method 900 includes creating, by the processing circuitry 206, receivables for any of the recipients 164 who have been overpaid based on the updated conditions.

At 916, the method 900 includes creating, by the processing circuitry 206, disbursements for any of the recipients 164 who have been underpaid based on the updated conditions.

For example, “updated conditions” comes from one of the plurality of sources such as the SDU or CSES and a user/recipient entering in new information. The CSES may receive information from a partner agency or data source. Updated conditions include order modification that change the amount, time span, number of dependents, or obligation type. All of these changes would trigger a balance recalculation process which would then create new transactions against the respective case balance and redetermine how previous payments were distributed and disbursed and make a determination on whether new disbursements are needed based on the new information. In another example, the processing circuitry 206 adjust account payment allocation percentages either in real-time or when there is a change in recipient circumstances (e.g., additional/new children added or removed from cases, etc.) across related accounts for which a single payment is received and requires allocation across those accounts.

In a non-limiting example, the balance recalculation process maintains two views of the transaction data. First, “historical view” which displays transactions based on chronological order as events happen. Second, “current view” which display transactions based on an order of events that would have happened if the system 200 knew about them at the time of the transactions. For example: Case 1 has an obligation for $100 per month and starting from Jan. 1, 2025, and accruals process charges $100 for January, $100 for February and then $100 for March. At this point, the historical and current views are the same, as shown below in Table 1. Thereafter, upon receiving new information or updated conditions, the processing circuitry 206 modifies the chronological order, and an amount of the accrual should have been set to $200/month. The user 102 would then update the obligated amount to $200 starting in January 2025. The results of the change caused due to updated conditions is depicted below in Table 2 and Table 3. In this way the system 200 maintains all cases related support payments accurately and provides details necessary for audit purposes.

TABLE 1
Historical and Current View

| Date | Transaction | Amount | Balance |
|---|---|---|---|
| Jan. 1, 2025 | Accrual | 100 | 100 |
| Feb. 1, 2025 | Accrual | 100 | 200 |
| Mar. 1, 2025 | Accrual | 100 | 300 |

TABLE 2
Current View

| Date | Transaction | Amount | Balance |
|---|---|---|---|
| Jan. 1, 2025 | Accrual | 100 | 100 |
| Feb. 1, 2025 | Accrual | 100 | 200 |
| Mar. 1, 2025 | Accrual | 100 | 300 |
| Mar. 2, 2025 | Recalculation | 300 | 600 |
| | Net Effect | | |

TABLE 3
Historical View

| Date | Transaction | Amount | Balance |
|---|---|---|---|
| Jan. 1, 2025 | Accrual | 200 | 200 |
| Feb. 1, 2025 | Accrual | 200 | 400 |
| Mar. 1, 2025 | Accrual | 200 | 600 |

The disclosed method with reference to FIG. 8, or one or more operations of the method 800 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as flash memory components) and executed on a computer (e.g., any suitable computer, such as a laptop computer, net book, Web book, tablet computing device, smartphone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry.

Particularly, the system 200 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processing circuitry 206 or the computer to perform one or more operations. A computer-readable medium storing, embodying, or encoded with a computer program, or similar language may be embodied as a tangible data storage device storing one or more software programs that are configured to cause the processing circuitry 206 or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (Compact Disc read only memory), CD-R (Compact Disc recordable), CD-R/W (Compact Disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by processing circuitry, an electronic file comprising a dataset related to financial transactions from a plurality of sources, the electronic file including payment identification data;
posting, by the processing circuitry, a receipt against a received transaction amount into one or more databases based on the payment identification data;
extracting, by the processing circuitry, payment transaction details based at least on the dataset, wherein the payment transaction details comprise a set of payers, a transaction identifier, a transaction date and time, payment amount, payment source information, at least one payment method, a transaction type, a receipt date, an effective payment date, and a transaction amount to be disbursed;
generating, by the processing circuitry, an allocation hierarchy based on a set of allocation parameters, the set of allocation parameters comprising at least a classification, an obligation category associated with the classification or subtypes of the obligation category, an allocation amount, the receipt date, and the effective payment date;
allocating, by the processing circuitry, the transaction amount across a accounts of the set of payers based at least on the allocation hierarchy, the allocation hierarchy defining a priority order in which different portions of the transaction amount are distributed across accounts of the set of payers based on the set of allocation parameters, wherein the priority order in which different portions of the transaction amount are distributed across accounts of the set of payers forms an organized hierarchy-based approach;
generating, by the processing circuitry, a distribution hierarchy based at least on the allocation hierarchy and the transaction amount to be disbursed to a corresponding recipient of a set of recipients, the distribution hierarchy comprising the set of recipients being categorized based on a first distribution type and a second distribution type, the distribution hierarchy defining routing of the transaction amount to be disbursed to the set of recipients;
assigning, by the processing circuitry, a respective portion of the transaction amount to each of the set of recipients according to the distribution hierarchy; and
electronically disbursing, by the processing circuitry, each portion of the transaction amount to the respective recipient account of the set of recipients through an electronic payment mechanism according to the priority order,
wherein the organized hierarchy-based approach is leveraged to efficiently allocate, distribute, and disburse transaction amounts over conventional financial management systems, enabling processing of a large volume of financial transactions and reducing resource requirements associated with the conventional financial management systems.

2-4. (canceled)

5. The method as claimed in claim 1, wherein the distribution hierarchy is modified based on receipt type, type of a case, a description related to the type of case, effective date and update date of the distribution hierarchy.

6. The method as claimed in claim 1, wherein the first distribution type comprises an assigned distribution type and the second distribution type comprises an unassigned distribution type.

7. The method as claimed in claim 1, further comprising updating, by the processing circuitry, results of the allocation hierarchy based on updated payment transaction details to reflect any changes in allocations of transaction amounts.

8. A system, comprising:
a memory comprising machine-readable instructions; and
processing circuitry operably connected to the memory, the processing circuitry configured to execute the machine-readable instructions to cause the system to:
receive an electronic file comprising a dataset associated with financial transactions from a plurality of sources, the electronic file including payment identification data;
post a receipt against a received transaction amount into one or more databases based on the payment identification data;
extract payment transaction details based at least on the dataset, wherein the payment transaction details comprise a set of payers, a transaction identifier, a transaction date and time, payment amount, payment source information, at least one payment method, a transaction type, a receipt date, an effective payment date, and a transaction amount to be disbursed;
generate an allocation hierarchy based on a set of allocation parameters, the set of allocation parameters comprising at least a classification, an obligation category associated with the classification or subtypes of the obligation category, an allocation amount, the receipt date, and the effective payment date;
allocate the transaction amount across accounts of the set of payers based at least on the allocation hierarchy, the allocation hierarchy defining a priority order in which different portions of the transaction amount are distributed across accounts of the set of payers based on the set of allocation parameters, wherein the priority order in which different portions of the transaction amount are distributed across accounts of the set of payers forms an organized hierarchy-based approach;
generate a distribution hierarchy based at least on the allocation hierarchy and the transaction amount to be disbursed to a corresponding recipient of a set of recipients, the distribution hierarchy comprising the set of recipients being categorized based on a first distribution type and a second distribution type, the distribution hierarchy defining routing of the transaction amount to be disbursed to the set of recipients;
assign a respective portion of the transaction amount to each of the set of recipients according to the distribution hierarchy; and
electronically disburse each portion of the transaction amount to the respective recipient account of the set of recipients through an electronic payment mechanism according to the priority order,
wherein the organized hierarchy-based approach is leveraged to efficiently allocate, distribute, and disburse transaction amounts over conventional financial management systems, enabling processing of a large volume of financial transactions and reducing resource requirements associated with the conventional financial management systems

9-11. (canceled)

12. The system as claimed in claim 8, wherein the distribution hierarchy is modified based on receipt type, type of a case, a description related to the type of case, effective date, and update date of the distribution hierarchy.

13. The system as claimed in claim 8, wherein the first distribution type comprises an assigned distribution type and the second distribution type comprises an unassigned distribution type.

14. The system as claimed in claim 8, wherein the processing circuitry is configured to update results of the allocation hierarchy based on updated payment transaction details to reflect any changes in allocations of transaction amounts.

15. A non-transitory computer-readable storage medium, comprising machine-readable instructions, the machine-readable instructions when executed by processing circuitry of a system enable the system to perform a method comprising steps of:
receiving an electronic file comprising a dataset related to financial transactions from a plurality of sources, the electronic file including payment identification data;
posting a receipt against a received transaction amount into one or more databases based on the payment identification data;
extracting payment transaction details based at least on the dataset, wherein the payment transaction details comprise a set of payers, a transaction identifier, a transaction date and time, payment amount, payment source information, at least one payment method, a transaction type, a receipt date, an effective payment date, and a transaction amount to be disbursed;
generating an allocation hierarchy based on a set of allocation parameters, the set of allocation parameters comprising at least a priority order, a classification, an obligation category associated with the classification or subtypes of the obligation category, an allocation amount, the receipt date, and the effective payment date;
allocating the transaction amount across accounts of the set of payers based at least on the allocation hierarchy, the allocation hierarchy defining a priority order in which different portions of the transaction amount are distributed across accounts of the set of payers based on the set of allocation parameters, wherein the priority order in which different portions of the transaction amount are distributed across accounts of the set of payers forms an organized hierarchy-based approach;
generating a distribution hierarchy based at least on the allocation hierarchy and the transaction amount to be disbursed to a corresponding recipient of a set of recipients, the distribution hierarchy comprising the set of recipients being categorized based on a first distribution type and a second distribution type, the distribution hierarchy defining routing of the transaction amount to be disbursed to the set of recipients;
assigning a respective portion of the transaction amount to each of the set of recipients according to the distribution hierarchy; and
electronically disbursing each portion of the transaction amount to the respective recipient account of the set of recipients through an electronic payment mechanism according to the priority order,
wherein the organized hierarchy-based approach is leveraged to efficiently allocate, distribute, and disburse transaction amounts over conventional financial management systems, enabling processing of a large volume of financial transactions and reducing resource requirements associated with the conventional financial management systems.

16-17. (canceled)

18. The non-transitory computer-readable storage medium as claimed in claim 15, wherein the distribution hierarchy is modified based on receipt type, type of a case, a description related to the type of case, effective date, and update date of the distribution hierarchy.

19. The non-transitory computer-readable storage medium as claimed in claim 15, wherein the first distribution type comprises an assigned distribution type and the second distribution type comprises an unassigned distribution type.

20. The non-transitory computer-readable storage medium as claimed in claim 15, further comprising updating results of the allocation hierarchy based on updated payment transaction details to reflect any changes in allocations of transaction amounts.
